(19) United States
(12) Patent Application Publication
(10) Pub. No.: US 2016/0115335 A1
(43) Pub. Date: Apr. 28, 2016

(54) LOW-OILING, SCRATCH-RESISTANT, AND SOLVENT-RESISTANT POLYCARBONATE FILM

(71) Applicant: COVESTRO DEUTSCHLAND AG, Leverkusen (DE)

(72) Inventors: Serguei KOSTROMINE, Swisttal-Buschhoven (DE); Joachim PETZOLDT, Monheim (DE)

(73) Assignee: Covestro Deutschland AG, Leverkusen (DE)

(21) Appl. No.: 14/897,694

(22) PCT Filed: Jun. 11, 2014
(86) PCT No.: PCT/EP2014/062060

§ 371 Date: Dec. 11, 2015

(30) Foreign Application Priority Data
Jun. 14, 2013 (EP) 13172191.2

(51) Int. Cl. C09D 125/12; C09D 133/14

(52) U.S. Cl. CPC C09D 125/12; C09D 133/14

(57) ABSTRACT

The present invention relates to a coating composition comprising at least one styrene-acrylonitrile copolymer in a content of at least 30% by weight of the solids content of the coating composition; at least 30% by weight of a UV-curable reactive diluent; 0.1 to 10 parts by weight of at least one photoinitiator; and at least one organic solvent, where the proportion of ethylenically unsaturated groups is at least 3 mol per kg of the solids content of the coating composition. The films coated therewith, especially polycarbonate films, have improved properties in terms of scratch resistance, solvent resistance and a reduced oiling effect, which makes them particularly suitable for use for production of plastics parts in film insert moulding processes.

The present invention relates to a coating composition for production of low-oiling scratch-resistant and solvent-resistant coatings, particularly on polycarbonate films. The present invention further relates to a laminate comprising a substrate and a coating obtainable from the coating composition, and to the use of the laminates for production of plastics parts in film insert moulding processes.

Film insert moulding technology has become established for the production of plastics parts in the injection moulding process. It involves first two- or three-dimensionally prefabricating the frontal surface of a part from a coated film and then filling or insert moulding it with a polymer melt from the reverse side.

It is often desirable that the front side has sufficient protection from chemical and mechanical effects. This is often achieved in the prior art by an appropriate coating or paint system on the surface. In order to avoid wet coating of the finished three-dimensional parts, it is advantageous that such a paint or coating system should already have been applied to the film which then runs through all the further forming steps with the film and is then ultimately cured, for example by UV exposure.

This gives rise to a very specific profile of properties for coated films which suit this technology. In the prior art, the term “formable hardcoating” has become established for this product class, meaning a film coating which is at first sufficiently blocking-resistant, but then can be thermally formed as desired together with the substrate and at the end receives the properties of a protective layer through UV curing.

Such a combination of properties, in the sense of blocking resistance and thermoplastic characteristics of the primary coating, together with the great latent potential for UV crosslinking, is difficult to implement.

Most of the approaches to a solution for this objective in the prior art comprise the use of macromonomers which are prepared principally by dual-cure processes, as described inter alia in Beck, Erich (BASF), Scratch resistant UV coatings for automotive applications, Pitture e Vernici, European Coatings (2006), 82(9), 10-19; Beck, Erich, Into the third dimension: three ways to apply UV coating technology to 3D-automotive objects, European Coatings Journal (2006), (4), 32, 34, 36, 38-39; Petzoldt, Joachim; Coloma, Fermín (BMS), New three-dimensionally formable hardcoat films, JOT, Journal fuer Oberflaechentechnik (2010), 50(9), 40-42; EP 2113527 A1, Petzoldt et al., Development of new generation hardcoated films for complex 3D-shaped FIM applications, RadTech Asia 2011, Conference Proceedings.

The insert moulding of these film products with, for example, polycarbonate melt (film insert moulding) results in the desired plastics parts.

High demands are made on the visual appearance of such plastics parts, which find wide use in automobiles, in all other modes of transport, electrical and electronic devices, and in the construction industry. Irregular rainbow phenomena, often referred to as “oiling”, destroy the visual impression desired. This unwanted effect is a particularly serious consideration when plastics parts are to be produced in glossy piano black.

The “oiling” effect arises through interference of two light beams reflected in one direction, one beam being reflected at the air/coating interface, while the other beam is reflected at the coating/substrate film interface beneath. The more light is reflected by the two surfaces, the more visible the effect can become. Glossy paint films on glossy substrates are a prerequisite for severe oiling. Exactly this case occurs when, for example, a smooth polycarbonate film (as sold, for example, under the Makrofol DE 1-1 brand name by the manufacturer Bayer MaterialScience AG) is covered with a shiny clearcoat material.

In such an application, smooth polycarbonate films having a relatively high refractive index of about 1.58 are often used, which are generally coated with an aliphatic-based coating material having a lower refractive index in an application-relevant coating thickness between 5 and 20 μm. As a result of thermal forming, the layer thickness of the coating on the component is also varied in a location-dependent manner, which can promote the development of a rainbow effect on the component overall.

It is known that the interference is dependent on the thickness of the coating and that the occurrence of interference is wavelength-dependent. This means that the play of the rainbow colours which appear alongside one another becomes particularly visible when wedge-shaped layer thickness variations occur in the coating. However, this is exactly what happens when the coated film is thermally formed and is elongated or stretched in places in the process. The selected production process itself thus creates the most favourable conditions for the unwanted rainbow effect.

The intensity of reflection depends not just on the quality of the surface, but also on the refractive index difference in the two media that form this interface. Little influence is possible over the front interface between the coating material and air. The reflection from the interface between coating material and substrate film can be minimized by matching the refractive index of the coating material as closely as possible to the refractive index of the polycarbonate used as the substrate film. For example, a polycarbonate film based on bisphenol A has a refractive index of 1.585 (sodium D line of 589 nm).

It has been found that, surprisingly, a thermally formable and subsequently UV-curable, low-“oiling” coating is realized when a coating composition comprising particular proportions of at least one styrene-acrylonitrile copolymer, of at least one reactive diluent, at least one photoinitiator in at least one common solvent, is used.

The present invention therefore provides the following:

a coating composition comprising
(a) at least one styrene-acrylonitrile copolymer in a content of at least 30% by weight of the solids content of the coating composition;
(b) at least 30% by weight of a UV-curable reactive diluent;
(c) 0.1 to 10 parts by weight of at least one photoinitiator; and
(d) at least one organic solvent,
where the proportion of ethylenically unsaturated groups is at least 3 mol per kg of the solids content of the coating composition.

The inventive coating composition can be obtained in a simple and efficient manner. Furthermore, coatings obtainable thereby have adequate blocking resistance on many surfaces such as, more particularly, the films considered for use in the film insert moulding process, but can then be thermally formed as desired together with the coated substrate and, after curing, for example by means of UV radiation, receive a surface having advantageous properties in terms of scratch resistance, solvent resistance and an at least reduced oiling effect.

The scratch resistance can be determined, for example, using the pencil hardness, as measurable on the basis of ASTM D 3363. An assessment of solvent resistance can be made on the basis of EN ISO 2812-3:2007. It is remarkable that the surface of the moulding obtained by the inventive coating of the film with the coating composition and final curing by UV radiation has very good durability, even with respect to solvents such as 1-methoxy-2-propyl acetate, xylene, ethyl acetate, methyl ethyl ketone, which are otherwise very harmful to polycarbonate surfaces.

The styrene-acrylonitrile copolymers used in the inventive coating composition are thermoplastics known by the abbreviation SAN (DIN EN ISO 1043-1 and DIN ISO 1629). The melting temperature or glass transition temperature to ISO 11357 for styrene-acrylonitrile copolymers is more than 100° C. The proportion of acrylonitrile is limited primarily by solubility in appropriate solvents. Up to an acrylonitrile content of 35%, the styrene-acrylonitrile copolymers have particularly advantageous solubility, which leads in turn to particularly advantageous properties in terms of the processability of the coating composition and the overall visual impression of the coatings obtained thereby. In a preferred embodiment, the styrene-acrylonitrile copolymer (a) has an acrylonitrile content in the range of ≧20 and ≦30%, particular preference being given to SAN copolymers having acrylonitrile contents in the range of 22 and ≦28%.

SAN copolymers usable for the present invention are commercially available, for example, under various brand names, for example Luran (manufacturer: Styrolution), Tyril (manufacturer: Styron), Kostil (manufacturer: Polymeri) and the Elix-200 series (manufacturer Elix Polymers). Products of this kind can also be purchased as poly(styrene-co-acrylonitrile) from the manufacturer Aldrich.

The styrene-acrylonitrile copolymer is an essential part of the inventive coating composition and of the inventive coating. The proportion of the at least one styrene-acrylonitrile copolymer in the solids content of the coating composition is at least 30% by weight, preferably at least 40% by weight, more preferably at least 45% by weight.

Reactive diluents usable with preference as component (b) of the inventive coating composition are bifunctional, trifunctional, tetrafunctional, pentafunctional or hexafunctional acrylic and/or methacrylic monomers. Preference is given to ester functions, especially acrylic ester functions. Suitable polyfunctional acrylic acid or methacrylic esters derive from aliphatic polyhydroxyl compounds having at least 2, preferably at least 3 and more preferably at least 4 hydroxyl groups, and preferably 2 to 12 carbon atoms.

Examples of such aliphatic polyhydroxyl compounds are ethylene glycol, propylene glycol, butane-1,4-diol, hexane-1,6-diol, diethylene glycol, triethylene glycol, glycerol, trimethylolpropane, pentarythritol, dipentaerythritol, tetramethylolethane and sorbitan. Examples of esters of said polyhydroxyl compounds, said esters being suitable with preference in accordance with the invention as bi- to hexafunctional acrylic and/or methacrylic monomers for the reactive diluent, are glycol diacrylate and dimethacrylate, butanediol diacrylate or dimethacrylate, dimethylolpropane diacrylate or dimethacrylate, diethylene glycol diacrylate or dimethacrylate, divinylbenzene, trimethylolpropane triacrylate or trimethacrylate, glyceryl triacrylate or trimethacrylate, pentaerythrityl tetraacrylate or tetramethacrylate, dipentaerythrityl penta-/hexaacrylate (DPHA), butane-1,2,3,4-tetraol tetraacrylate or tetramethacrylate, tetramethylolethane tetraacrylate or tetramethacrylate, 2,2-dihydroxypropane-1,3-diol tetraacrylate or tetramethacrylate, diurethane dimethacrylate (UDMA), sorbitan tetra-, penta- or hexaacrylate or the corresponding methacrylates. It is also possible to additionally use mixtures of crosslinking monomers having two to four or more ethylenically unsaturated, free-radically polymerizable groups.

Additionally in accordance with the invention, it is possible to use, as reactive diluents or components b) of the inventive coating composition, alkoxylated di-, tri-, tetra-, penta- and hexaacrylates or -methacrylates. Examples of alkoxylated diacrylates or -methacrylates are alkoxylated, preferably ethoxylated, methanediol diacrylate, methanediol dimethacrylate, glyceryl diacrylate, glyceryl dimethacrylate, neopentyl glycol diacrylate, neopentyl glycol dimethacrylate, 2-butyl-2-ethylpropane-1,3-diol diacrylate, 2-butyl-2-ethylpropane-1,3-diol dimethacrylate, trimethylolpropane diacrylate or trimethylolpropane dimethacrylate.

Examples of alkoxylated triacrylates or -methacrylates are alkoxylated, preferably ethoxylated, pentaerythrityl triacrylate, pentaerythrityl trimethacrylate, glyceryl triacrylate, glyceryl trimethacrylate, butane-1,2,4-triol triacrylate, butane-1,2,4-triol trimethacrylate, trimethylolpropane triacrylate, trimethylolpropane trimethacrylate, tricyclodecanedimethanol diacrylate, tricyclodecanedimethanol dimethacrylate, ditrimethylolpropane tetraacrylate or ditrimethylolpropane tetramethacrylate.

Examples of alkoxylated tetra-, penta- or hexaacrylates are alkoxylated, preferably ethoxylated, pentaerythrityl tetraacrylate, dipentaerythrityl tetraacrylate, dipentaerythrityl pentaacrylate, dipentaerythrityl hexaacrylate, pentaerythrityl tetramethacrylate, dipentaerythrityl tetramethacrylate, dipentaerythrityl pentamethacrylate or dipentaerythrityl hexamethacrylate.

In the alkoxylated diacrylates or -methacrylates, triacrylates or -methacrylates, tetraacrylates or -methacrylates, pentaacrylates or -methacrylates and/or alkoxylated hexaacrylates or -methacrylates in component b), all the acrylate groups or methacrylate groups or only some of the acrylate groups or methacrylate groups in the respective monomer may be bonded to the corresponding radical via alkylene oxide groups. It is also possible to use any desired mixtures of such wholly or partly alkoxylated di-, tri-, tetra-, penta- or hexaacrylates or -methacrylates. In this case, it is also possible that the acrylate or methacrylate group(s) is/arc bonded to the aliphatic, cycloaliphatic or aromatic radical of the monomer via a plurality of successive alkylene oxide groups, preferably ethylene oxide groups. The mean number of alkylene oxide or ethylene oxide groups in the monomer is stated by the alkoxylation level or ethoxylation level. The alkoxylation level or ethoxylation level may preferably be from 2 to 25, particular preference being given to alkoxylation levels or ethoxylation levels of 2 to 15, most preferably of 3 to 9.

Likewise in accordance with the invention, reactive diluents or components b) of the inventive coating composition may be oligomers which belong to the class of the aliphatic urethane acrylates or of the polyester acrylates or polyacryloylacrylates. The use thereof as paint binders is known and is described in Chemistry & Technology of UV & EB Formulation for Coatings, Inks & Paints, vol. 2, 1991, SITA Technology, London (P. K. T. Oldring (ed.) on p. 73-123 (Urethane Acrylates) and p. 123-135 (Polyester Acrylates). Commercially available examples which are suitable within the inventive context include aliphatic urethane acrylates such as Ebecryl® 4858, Ebecryl® 284, Ebecryl® 265, Ebecryl® 264, Ebecryl® 8465, Ebecryl® 8402 (each manufactured by Cytec Surface Specialities), Craynor® 925 from Cray Valley, Viaktin® 6160 from Vianova Resin, Desmolux VP LS 2265 from Bayer MaterialScience AG, Photomer 6891 from Cognis, or else aliphatic urethane acrylates dissolved in reactive diluents, such as Laromer® 8987 (70% in hexanediol diacrylate) from BASF AG, Desmolux U 680 H (80% in hexanediol diacrylate) from Bayer MaterialScience AG, Craynor® 945B85 (85% in hexanediol diacrylate), Ebecryl® 294/25HD (75% in hexanediol diacrylate), Ebecryl® 8405 (80% in hexanediol diacrylate), Ebecryl® 4820 (65% in hexanediol diacrylate) (each manufactured by Cytec Surface Specialities) and Craynor® 963B80 (80% in hexanediol diacrylate), each from Cray Valley, or else polyester acrylates such as Ebecryl® 810, 830, or polyacryloylacrylates such as Ebecryl®, 740, 745, 767 or 1200 from Cytec Surface Specialities.

In a further preferred embodiment, the reactive diluent (b) comprises alkoxylated diacrylates and/or dimethacrylates, alkoxylated triacrylates and/or trimethacrylates, alkoxylated tetraacrylates and/or tetramethacrylates, alkoxylated pentaacrylates and/or pentamethacrylates, alkoxylated hexaacrylates and/or hexamethacrylates, aliphatic urethane acrylates, polyester acrylates, polyacryloylacrylates and mixtures thereof.

In a further preferred embodiment, the reactive diluent (b) of the inventive coating composition comprises dipentaerythrityl penta-/hexaacrylate.

For the adjustment of the refractive index of the coating, aromatic multifunctional monomers are advantageously suitable as reactive diluents (b) in the inventive coating composition. In a further embodiment of the present invention, the at least one reactive diluent (b) may comprise aromatic multifunctional monomers, preferably unsaturated aromatic urethane acrylates, acrylated derivatives of bisphenol A and/or acrylated derivatives of divinylbenzene. Acrylated derivatives of bisphenol A can be purchased, for example, under the Ebecryl 150 and Ebecryl 600 trade names via the manufacturer Cytec and under the Desmolux U500 trade name from the manufacturer Bayer MaterialScience. In the context of the present invention, it is also possible to use mixtures of aliphatic and aromatic reactive diluents.

The invention also encompasses mixtures of the abovementioned crosslinking multifunctional monomers with monofunctional monomers such as, more particularly, methyl methacrylate or styrene. The proportion of the multifunctional monomers in such a mixture is preferably at least 20% by weight.

The reactive diluent is an essential part of the inventive coating composition and of the inventive coating. The total proportion of the at least one reactive diluent in the solids content of the coating composition is at least 30% by weight, preferably at least 40% by weight, more preferably at least 45% by weight.

The content of ethylenically unsaturated groups has a significant influence on the achievable durability properties of the radiation-cured coating. Therefore, the inventive coating composition contains a content of ethylenically unsaturated groups of at least 3.0 mol per kg of solids content of the coating composition, preferably at least 3.5 mol per kg, more preferably at least 4.0 mol per kg of solids content of the coating composition. This content of ethylenically unsaturated groups is also well known to the person skilled in the art by the term “double bond density”.

The term “at least one photoinitiator” in the inventive coating composition encompasses the standard, commercially available compounds known to those skilled in the art, for example α-hydroxyketones, benzophenone, α,α-diethoxyacetophenone, 4,4-diethylaminobenzophenone, 2,2-dimethoxy-2-phenylacetophenone, 4-isopropylphenyl 2-hydroxy-2-propyl ketone, 1-hydroxycyclohexyl phenyl ketone, isoamyl p-dimethylaminobenzoate, methyl 4-dimethylaminobenzoate, methyl o-benzoylbenzoate, benzoin, benzoin ethyl ether, benzoin isopropyl ether, benzoin isobutyl ether, 2-hydroxy-2-methyl-1-phenylpropan-1-one, 2-isopropylthioxanthone, dibenzosuberone, 2,4,6-trimethylbenzoyldiphenylphosphine oxide, bisacylphosphine oxide and others, said photoinitiators being utilizable alone or in combination of two or more or in combination with one of the above polymerization initiators.

UV photoinitiators used may, for example, be IRGACURE® products from BASF, for example the products IRGACURE® 184, IRGACURE® 500, IRGACURE® 1173, IRGACURE®2959, IRGACURE® 745, IRGACURE® 651, IRGACURE® 369, IRGACURE® 907, IRGACURE®1000, IRGACURE® 1300, IRGACURE® 819, IRGACURE® 819DW, IRGACURE® 2022, IRGACURE® 2100, IRGACURE® 784, IRGACURE® 250; in addition, the DAROCUR® products from BASF are used, for example the products DAROCUR® MBF, DAROCUR® 1173, DAROCUR® TPO, DAROCUR® 4265. Another example of a UV photoinitiator usable in the inventive coating composition can be purchased under the Esacure One trade name from the manufacturer Lamberti.

Photoinitiators are present in the coating composition at in the range from ≧0.1 to ≦10 parts by weight of the solids content of the coating composition.

The coating composition should additionally contain, over and above the 100 parts by weight of components a) to c), one or more organic solvents.

With regard to the preferred end use of the inventive coating composition, the solvents used are preferably those which do not attack polycarbonate. Such solvents are preferably alcohols.

Particular preference is given here to 1-methoxy-2-propanol, diacetone alcohol, 2,2,3,3-tetrafluoropropanol and mixtures thereof. Very particular preference is given to diacetone alcohol and mixtures thereof with 1-methoxy-2-propanol, and among these to those including at least 50% by weight of diacetone alcohol.

The coating material composition preferably contains, in addition to the 100 parts by weight of components a) to c), 0 to 900 parts by weight, more preferably 100 to 850 parts by weight, most preferably 200 to 800 parts by weight, of the at least one organic solvent.

The coating composition may additionally optionally contain, over and above the 100 parts by weight of components a) to c), one or more further coatings additives. Such coatings additives may be selected, for example, from the group comprising stabilizers, levelling agents, surface additives, pigments, dyes, inorganic nanoparticles, adhesion promoters, UV absorbers, IR absorbers, preferably from the group comprising stabilizers, levelling agents, surface additives and inorganic nanoparticles. The paint composition preferably contains, in addition to the 100 parts by weight of components a) to c), 0 to 35 parts by weight, more preferably 0 to 30 parts by weight, most preferably 0.1 to 20 parts by weight, of at least one further coatings additive. Preferably, the total proportion of all the coatings additives present in the coating material composition is 0 to 35 parts by weight, more preferably 0 to 30 parts by weight, most preferably 0.1 to 20 parts by weight.

The coating material composition may comprise inorganic nanoparticles to increase the mechanical durability, for example scratch resistance and/or pencil hardness.

Useful nanoparticles include inorganic oxides, mixed oxides, hydroxides, sulphates, carbonates, carbides, borides and nitrides of elements of main group II to IV and/or elements of transition group I to VIII of the Periodic Table, including the lanthanides. Preferred nanoparticles are silicon oxide, aluminium oxide, cerium oxide, zirconium oxide, niobium oxide, zinc oxide or titanium oxide nanoparticles, particular preference being given to silicon oxide nanoparticles.

The particles used preferably have mean particle sizes (measured by means of dynamic light scattering in dispersion, determined as the Z-average) of less than 200 nm, preferably of 5 to 100 nm, more preferably 5 to 50 nm. Preferably at least 75%, more preferably at least 90%, even more preferably at least 95%, of all the nanoparticles used have the sizes defined above.

The coating composition can be produced in a simple manner by first of all dissolving the polymer completely in the solvent at room temperature or at elevated temperatures and then the other obligatory and any optional components to the solution which has been cooled to room temperature, either combining them in the absence of solvent(s) and mixing them together by stirring, or in the presence of solvent(s), for example adding them to the solvent(s), and mixing them together by stirring. Preferably, first the photoinitiator is dissolved in the solvent(s) and then the further components are added. This is optionally followed by a purification by means of filtration, preferably by means of fine filtration.

The present invention further provides a laminate comprising a substrate and a substrate coating obtainable by coating the substrate with the coating composition according to the present invention. This provides, in accordance with the invention, a coated substrate having advantageous surface properties in terms of scratch resistance, solvent resistance and anti-oiling effect.

Since the avoidance of an oiling effect in the field of production of plastics parts by means of the film insert moulding process is of particular significance, and since the present invention advantageously achieves an improvement, the substrate to be coated, according to the present invention, preferably comprises a film.

Films used for coating are preferably thermoplastics such as polycarbonate, polyacrylate or poly(meth)acrylate, polysulphones, polyesters, thermoplastic polyurethane and polystyrene, and the copolymers and mixtures (blends) thereof. Suitable thermoplastics are, for example, polyacrylates, poly(meth)acrylates (e.g. PMMA; e.g. Plexiglas® from the manufacturer Röhm), cycloolefin copolymers (COC; e.g. Topas® from the manufacturer Ticona; Zenoex® from the manufacturer Nippon Zeon or Apel® from the manufacturer Japan Synthetic Rubber), Polysulfone (Ultrason@ from the manufacturer BASF or Udel® from the manufacturer Solvay), polyesters, for example PET or PEN, polycarbonate (PC), polycarbonate/polyester blends, e.g. PC/PET, polycarbonate/polycyclohexylmethanol cyclohexanedicarboxylate (PCCD; Xylecs® from GE), polycarbonate/PBT and mixtures thereof.

In a particularly advantageous and preferred embodiment of the present invention, the film of the inventive laminate comprises polycarbonate or copolycarbonate.

Because of its excellent impact resistance with simultaneous transparency, polycarbonate can also be used in the context of the present invention as a thermoplastic polymer for insert moulding or filling of the 3D-formed film coated with the protective layer used in a film insert moulding process for production of a 3D moulding or plastics part. In a likewise preferred embodiment of the present invention, the thermoplastic polymer thus comprises polycarbonate. Polycarbonates and polycarbonate formulations, and also polycarbonate films, suitable for the invention are obtainable, for example, under the Makrolon®, Bayblend® and Makroblend® trade names (Bayer MaterialScience).

Suitable polycarbonates for the production of the inventive polycarbonate compositions are all the known polycarbonates. These are homopolycarbonates, copolycarbonates and thermoplastic polyester carbonates. The suitable polycarbonates preferably have mean molecular weights M̅_{w} of 18 000 to 40 000, preferably of 26 000 to 36 000 and especially of 28 000 to 35 000, determined by measuring the relative solution viscosity in dichloromethane or in mixtures of equal weights of phenol/o-dichlorobenzene, calibrated by light scattering.

The polycarbonates are preferably prepared by the interfacial process or the melt transesterification process, which have been described many times in the literature. With regard to the interfacial process, reference is made by way of example to H. Schnell, Chemistry and Physics of Polycarbonates, Polymer Reviews, vol. 9, Interscience Publishers, New York 1964 S. 33 ff., to Polymer Reviews, vol. 10, “Condensation Polymers by Interfacial and Solution Methods”, Paul W. Morgan, Interscience Publishers, New York 1965, ch. VIII, p. 325, to Drs. U. Grigo, K. Kircher and P. R- Müller “Polycarbonate” [Polycarbonates] in Becker/Braun, Kunststoff-Handbuch [Polymer Handbook], volume 3/1, Polycarbonate, Polyacetale. Polyester, Celluloseester [Polycarbonates, Polyacetals, Polyesters, Cellulose Esters], Carl Hanser Publishers, Munich, Vienna, 1992, p. 118-145, and to EP-A 0 517 044. The melt transesterification process is described, for example, in Encyclopedia of Polymer Science, vol. 10 (1969), Chemistry and Physics of Polycarbonates, Polymer Reviews, H. Schnell, vol. 9, John Wiley and Sons, Inc. (1964), and in patent specifications DE-B 10 31 512 and US-B 6 228 973.

The polycarbonates can be obtained from reactions of bisphenol compounds with carbonic acid compounds, especially phosgene, or diphenyl carbonate or dimethyl carbonate in the melt transesterification process. Particular preference is given here to homopolycarbonates based on bisphenol A and copolycarbonates based on monomers bisphenol A and 1,1-bis(4-hydroxyphenyl)-3,3,5-trimethylcyclohexane. Further bisphenol compounds which can be used for the polycarbonate synthesis are disclosed, inter alia, in WO-A 2008037364, EP-A 1 582 549, WO-A 2002026862, WO-A 2005113639.

The polycarbonates may be linear or branched. It is also possible to use mixtures of branched and unbranched polycarbonates.

Suitable branching agents for polycarbonates are known from the literature and are described, for example, in patent specifications US-B 4 185 009, DE-A 25 00 092, DE-A 42 40 313, DE-A 19 943 642, US-B 5 367 044 and in literature cited therein. Furthermore, the polycarbonates used may also be intrinsically branched, in which case no branching agent is added in the course of polycarbonate preparation. One example of intrinsic branches is that of so-called Fries structures, as disclosed for melt polycarbonates in EP-A 1 506 249.

In addition, it is possible to use chain terminators in the polycarbonate preparation. The chain terminators used are preferably phenols such as phenol, alkylphenols such as cresol and 4-tert-butylphenol, chlorophenol, bromophenol, cumylphenol or mixtures thereof.

The polymer composition(s) of the film or of the thermoplastic polymer of the 3D moulding may additionally comprise additives, for example UV absorbers, IR absorbers and other customary processing aids, especially demoulding agents and fluxes, and also the customary stabilizers, especially thermal stabilizers, and also antistats, pigments, colourants and optical brighteners. In every layer, different additives or concentrations of additives may be present.

The present invention further provides a process for producing a coated film, comprising the steps of

(i) coating a film with a moulding composition comprising
(a) at least one styrene-acrylonitrile copolymer in a content of at least 30% by weight of the solids content of the coating composition;
(b) at least 30% by weight of a UV-curable reactive diluent;
(c) 0.1 to 10 parts by weight of at least one photoinitiator; and
(d) at least one organic solvent,
where the proportion of ethylenically unsaturated groups is at least 3 mol per kg of the solids content of the coating composition;
   (ii) drying the coating;
   (iii) optionally cutting the film to size and/or delaminating, printing and/or thermally or mechanically forming the film;
   (iv) irradiating the coating with UV radiation to cure the coating.

In this context, the coating composition with its constituents and the term “films” are the same ones which have already been elucidated in the context of the present invention, in combination with one another as well. In a particularly preferred embodiment, the film comprises polycarbonate or copolycarbonate.

The film can be coated with the coating composition by the standard methods for coating films with fluid coating compositions, for example by knife-coating, spraying, pouring, flow-coating, dipping, rolling or spin-coating. The flow-coating process can be effected manually with a hose or suitable coating head, or automatically in a continuous run by means of flow-coating robots and optionally slot dies. Preference is given to the application of the coating composition by a roll-to-roll transfer. In this case, the surface of the film to be coated may be pretreated by cleaning or activation.

The drying follows the application of the coating composition to the film. For this purpose, more particularly, elevated temperatures in ovens, and moving and optionally also dried air, for example in convection ovens or by means of nozzle dryers, and thermal radiation such as IR and/or NIR, are employed. In addition, it is possible to use microwaves. It is possible and advantageous to combine a plurality of these drying processes. The drying of the coating in step (II) preferably comprises flash-off at room temperature and/or elevated temperature, such as preferably at 20-200° C., more preferably at 40-120° C. After the coating has been dried, it is blocking-resistant, and so the coated substrate, especially the coated film, can be laminated, printed and/or thermally formed. Forming in particular is preferred in this context, since merely the forming of a coated film here can define the mould for a film insert moulding process for production of a three-dimensional plastics part.

Advantageously, the conditions for the drying are selected such that the elevated temperature and/or the thermal radiation does not trigger any polymerization (crosslinking) of the acrylate or methacrylate groups, since this can impair formability. In addition, the maximum temperature attained should appropriately be selected at a sufficiently low level that the film does not deform in an uncontrolled manner.

After the drying/curing step, the coated film, optionally after lamination with a protective film on the coating, can be rolled up. The film can be rolled up without the coating sticking to the reverse side of the substrate film or of the laminating film. However, it is also possible to cut the coated film to size and to send the cut sections individually or as a stack to further processing. Particular preference is given in this context to the thermal forming of the coated film to a three-dimensional mould, as undertaken as a preparatory step for insert moulding of the film with a thermoplastic polymer such as polycarbonate in a film insert moulding process. In a preferred embodiment, step (iii) comprises the cutting-to-size and thermal forming of the coated film.

Curing with actinic radiation is understood to mean the free-radical polymerization of ethylenically unsaturated carbon-carbon double bonds by means of initiator radicals which are released, for example, from the above-described photoinitiators through irradiation with actinic radiation.

The radiative curing is preferably effected by the action of high-energy radiation, i.e. UV radiation or daylight, for example light of wavelength ≧200 nm to ≦750 nm, or by irradiation with high-energy electrons (electron beams, for example ≧90 keV to ≦300 keV). The radiation sources used for light or UV light are, for example, moderate- or high-pressure mercury vapour lamps, wherein the mercury vapour may be modified by doping with other elements such as gallium or iron. Lasers, pulsed lamps (known by the name UV flashlight emitters), halogen lamps or excimer emitters are likewise usable. The emitters may be installed at a fixed location, such that the material to be irradiated is moved past the radiation source by means of a mechanical device, or the emitters may be mobile, and the material to be irradiated does not change position in the course of curing. The radiation dose typically sufficient for crosslinking in the case of UV curing is in the range from ≧80 mJ/cm² to ≦5000 mJ/cm².

In a preferred embodiment, the actinic radiation is therefore light in the UV light range.

The radiation can optionally be performed with exclusion of oxygen, for example under inert gas atmosphere or reduced-oxygen atmosphere. Suitable inert gases are preferably nitrogen, carbon dioxide, noble gases or combustion gases. In addition, the radiation can be effected by covering the coating with media transparent to the radiation. Examples thereof are polymer films, glass or liquids such as water.

According to the radiation dose and curing conditions, the type and concentration of any initiator used can be varied or optimized in a manner known to those skilled in the art or by exploratory preliminary tests. For curing of the formed films, it is particularly advantageous to conduct the curing with several emitters, the arrangement of which should be selected such that every point on the coating receives substantially the optimal radiation dose and intensity for curing. More particularly, unirradiated regions (shadow zones) should be avoided.

In addition, according to the film used, it may be advantageous to select the irradiation conditions such that the thermal stress on the film does not become too great. In particular, thin films and films made from materials having a low glass transition temperature can have a tendency to uncontrolled deformation when a particular temperature is exceeded as a result of the irradiation. In these cases, it is advantageous to allow a minimum level of infrared radiation to act on the substrate, by means of suitable filters or a suitable design of the emitters. In addition, reduction of the corresponding radiation dose can counteract uncontrolled deformation. However, it should be noted that a particular dose and intensity in the irradiation are needed for maximum polymerization. It is particularly advantageous in these cases to conduct curing under inert or reduced-oxygen conditions, since the required dose for curing decreases when the oxygen content is reduced in the atmosphere above the coating.

Particular preference is given to using mercury emitters in fixed installations for curing. In that case, photoinitiators are used in concentrations of ≧0.1% by weight to ≦10% by weight, more preferably of ≧0.2% by weight to ≦3.0% by weight, based on the solids content of the coating. These coatings are preferably cured using a dose of ≧80 mJ/cm² to ≦5000 mJ/cm².

Insert moulding of the coated film with a thermoplastic polymer, such as polycarbonate, on completion of curing of the film coating and the optional, usually desirable, forming of the coated film is well known to the person skilled in the art in the form of the film insert moulding process as described, for example, in WO 2004/082926 A1 and WO 02/07947 A1. In a preferred embodiment of the process according to the invention, the reverse coating of the film in step (V) is effected by means of extrusion or injection moulding, preferably with polycarbonate melt. The processes of extrusion and of injection moulding for this purpose are well known to those skilled in the art and are described, for example, in “Handbuch Spritzgieβen” [Injection Moulding Handbook], Friedrich Johannnaber/Walter Michaeli, Munich; Vienna: Hanser, 2001, ISBN 3-446-15632-1 or “Anleitung zum Bau von Spritzgieβwerkzeugen” [Introduction to the Construction of Injection Moulds], Menges/Michaeli/Mohren, Munich; Vienna: Hanser, 1999, ISBN 3-446-21258-2.

On account of the excellent properties in terms of scratch resistance, solvent resistance and the reduced oiling effect of the surfaces, the present invention further provides for the use of the coating composition according to at least one of claims 1 to 10 or of the laminate according to at least one of claims 11 to 13 for production of plastics parts in film insert moulding processes. In a preferred embodiment, the inventive use comprises the production of plastics parts for the automotive, transport, electrical, electronics and construction industries.

The present invention further provides a 3D moulding or plastics part obtainable by film insert moulding, comprising a film, preferably a polycarbonate film, and a coating which forms the surface of the moulding and is obtainable by coating with the inventive coating composition, and a thermoplastic polymer, preferably polycarbonate.

### EXAMPLES

### Assessment Methods

The layer thickness of the coatings was measured by observing the cutting-edge in an Axioplan optical microscope manufactured by Zeiss. Method—reflected light, bright field, magnification 500×.

### Assessment of Blocking Resistance

Conventional test methods as described, for instance, in DIN 51350 are insufficient to simulate the blocking resistance of rolled-up, pre-dried, coated films, and therefore the following test was employed: The coating materials were applied to Makrofol DE 1-1 (375 μm) with a conventional coating bar (target wet film thickness 100 μm). After a flash-off phase at 20° C. to 25° C. for 10 min, the coated films were dried in an air circulation oven at 110° C. for 10 min. After a cooling phase for 1 min, a commercial GH-X173 natur pressure-sensitive lamination film (from Bischof und Klein, Lengerich, Germany) was applied to the dried coated film with a plastic roller over an area of 100 mm×100 mm. Subsequently, the laminated film piece was subjected to a weight of 10 kg over the full area for 1 hour. Thereafter, the lamination film was removed and the coated surface was assessed visually.

### Assessment of Pencil Hardness

The pencil hardness was measured analogously to ASTM D 3363 using an Elcometer 3086 Scratch boy (Elcometer Instruments GmbH, Aalen, Germany) under a load of 500 g, unless stated otherwise.

### Assessment of Steel Wool Scratching

The steel wool scratching is determined by sticking a piece of No. 00 steel wool (Oskar Weil GmbH Rakso, Lahr, Germany) onto the flat end of a 500 g fitter's hammer, the area of the hammer being 2.5 cm×2.5 cm, i.e. approximately 6.25 cm². The hammer is placed onto the surface to be tested without applying additional pressure, such that a defined load of about 560 g is attained. The hammer is then moved back and forth 10 times in twin strokes. Subsequently, the stressed surface is cleaned with a soft cloth to remove fabric residues and coating particles. The scratching is characterized by haze and gloss values, measured transverse to the scratching direction, with a Micro HAZE plus (20° gloss and haze; Byk-Gardner GmbH, Geretsried, Germany). The measurement is effected before and after scratching. The differential values for gloss and haze before and after stress are reported as Δgloss and Δhaze.

### Assessment of Solvent Resistance

The solvent resistance of the coatings was typically tested with isopropanol, xylene, 1-methoxy-2-propyl acetate, ethyl acetate, methyl ethyl ketone, in technical-grade quality. The solvents were applied to the coating with a soaked cotton bud and protected from vaporization by covering. Unless stated otherwise, a contact time of 60 minutes at about 23° C. was observed. After the end of the contact time, the cotton bud is removed and the test surface is wiped clean with a soft cloth. The inspection is immediately effected visually and after gentle scratching with a fingernail.

A distinction is made between the following levels:
0=unchanged; no change visible; cannot be damaged by scratching.
1=slight swelling visible, but cannot be damaged by scratching.
2=change clearly visible, can barely be damaged by scratching.
3=noticeable change, surface destroyed after firm fingernail pressure.
4=significant change, scratched through to the substrate after firm fingernail pressure.
5=destroyed; the coating is already destroyed when the chemical is wiped away; the test substance cannot be removed (has eaten into the surface).

Within this assessment, the test is typically passed with the ratings of 0 and 1. Ratings of >1 represent a “fail”.

### Assessment of Oiling Effect

The “oiling effect” is also referred to as the “Newton ring effect”. Newton rings occur as an irregular interference pattern on the surface of coated parts when they are viewed in reflection under white light. On a reflective, shiny surface, a light beam is reflected both at the outer surface of a coated component and at the surface of the coated substrate beneath. If a path difference in the region of λ/2 occurs between the two reflected beams, this wavelength is attenuated or even extinguished by interference, and the white light originally emitted is subject to local colour change in reflection. These patterns can also be detected as oscillations in the reflection spectrum of coated surfaces (coated films here). The intensity and frequency of these oscillations is a measure of the occurrence of the Newton ring effect.

The measurements used to determine the oiling effect are taken from transmission and reflection spectra which have been recorded with a spectrometer from STEAG ETA-Optik, CD-Measurement System ETA-RT. The direct reflection was measured at a viewing angle of 0°.

The index for the Newton rings was determined from the reflection spectra as follows:

mPV: maximum peak-valley ratio in % in the range of 400-650 nm.
mPV/2: amplitude of oscillation in %
R: reflection at the corresponding wavelength in %
Newton rings=mPV/2/R·1000

The wavelength ranges below 400 nm and above 650 nm are not considered because colour contrasts in these ranges are so small that no interference effects perceptible to the naked eye are visible.

### Example 1

### Production of a Coating Composition

50 g of Luran® 368 R (manufacturer: Styrolution) were dissolved in 142 g of a mixture (1:1) of 1-methoxy-2-propanol and diacetone alcohol at 100° C. within about 3 h. The solution was cooled down to about 30° C. Separately, the following components were dissolved in 83 g of the mixture (1:1) of 1-methoxy-2-propanol and diacetone alcohol at room temperature: 50 g of dipentaerythrityl penta/hexaacrylate (DPHA, manufacturer: Cytec), 2 g of Esacure One (manufacturer: Lamberti), 1 g of Darocur 4265 (manufacturer BASF), 0.125 g of BYK 333 (manufacturer: BYK). The second solution was added to the polymer solution while stirring. The mixture was stirred at room temperature and with shielding from direct incidence of light at room temperature for another 3 h, dispensed and left to stand for 1 day. The yield was 320 g, the viscosity (23° C.; DIN EN ISO 3219)) 2500 mPas at a shear rate of 27.3 l/s. The solids content was 31.4% by weight and the calculated double bond density in the solids content of the coating composition was about 5.1 mol/kg.

### Example 2

### Production of a Coating Composition

117 g of Luran® 368 R (manufacturer: Styrolution) were dissolved in 284 g of a mixture (2:3) of 1-methoxy-2-propanol and diacetone alcohol at 100° C. within about 3 h. The solution was cooled down to about 30° C. Separately, the following components were dissolved in 166 g of a mixture (2:3) of 1-methoxy-2-propanol and diacetone alcohol at room temperature: 117 g of dipentaerythrityl penta-/hexaacrylate (DPHA, manufacturer: Cytec), 4.7 g of Esacure One (manufacturer: Lamberti), 2.35 g of Darocur 4265 (manufacturer: BASF) and 0.25 g of BYK 333 (manufacturer: BYK). The second solution was added to the polymer solution while stirring. The coating material was stirred at room temperature and with shielding from direct incidence of light for another 3 h, dispensed and left to stand for 1 day. The yield was 650 g, the viscosity (23° C., DIN EN ISO 3219) was 4990 mPas, the solids content was 35% by weight and the calculated double bond density in the solids content of the coating composition was about 5.1 mol/kg.

### Example 3

### Production of a Coating Composition

95 g of poly(styrene-co-acrylonitrile) (manufacturer: Aldrich, catalogue no. 182850, M_{w} 165 000 (GPS, figure from Aldrich), 25% acrylonitrile (figure from Aldrich)) were dissolved in 270 g of a mixture (2:3) of 1-methoxy-2-propanol and diacetone alcohol at 100° C. within about 3 h. The solution was cooled down to about 30° C. Separately, the following components were dissolved in 158 g of a mixture (2:3) of 1-methoxy-2-propanol and diacetone alcohol at room temperature: 95 g of dipentaerythrityl penta-/hexaacrylate (DPHA, manufacturer: Cytec), 3.8 g of Esacure One (manufacturer: Lamberti), 1.9 g of Darocur 4265 (manufacturer: BASF) and 0.24 g of BYK 333 (manufacturer: BYK). The second solution was added to the polymer solution while stirring. The mixture was stirred at room temperature and with shielding from direct incidence of light for another 3 h, dispensed and left to stand for 1 day. The yield was 623 g, the viscosity (23° C., DIN EN ISO 3219) was 1470 mPas, the solids content was 31.4% by weight and the calculated double bond density in the solids content of the was about 5.1 mol/kg.

### Comparative Example 1

### Production of a Non-Inventive Coating Composition

25 g of poly(methyl methacrylate) (manufacturer: Aldrich, catalogue no. 182265, M_{w} 996 000 (GPS, figure from Aldrich) were dissolved in 142 g of 1-methoxy-2-propanol at 100° C. within about 5 h. The solution was cooled down to about 30° C. Separately, the following components were dissolved in 83 g of 1-methoxy-2-propanol at room temperature: 25 g of dipentaerythrityl penta-/hexaacrylate (DPHA, manufacturer: Cytec), 2.0 g of Irgacure 1000 (manufacturer: BASF), 1.0 g of Darocur 4265 (manufacturer: BASF) and 0.0625 g of BYK 333 (manufacturer: BYK). The second solution was added to the polymer solution while stirring. The coating material was stirred at room temperature and with shielding from direct incidence of light for another 3 h, dispensed and left to stand for 1 day. The yield was 270 g, the viscosity (23° C., DIN EN ISO 3219) was 9060 mPas, the solids content was 19% by weight and the calculated double bond density in the solids content was about 5.1 mol/kg.

### Example 4

### Testing of the Solubility of Various SAN Products

The solubility of various commercially available SAN products was tested in three solvents particularly preferred for the field of use of the present invention: in 1-methoxy-2-propanol (MP-ol), in diacetone alcohol (DAA) and in a mixture (1:1) of the two. For the testing, the aim was a use-relevant concentration of 25% by weight of the polymer in each solvent. The dissolution test was conducted at 120° C. while stirring within 4 h. Then an intermediate result was registered. The solution was then cooled to room temperature and a final result was registered. “Insoluble” means precipitation of the polymer in the course of cooling of the solution.

| | Composition, % by wt. | | | | | | | | |
|---|---|---|---|---|---|---|---|---|---|
| | Acrylo- | | α- | MP-ol | | DAA | | MP-ol/DAA = 1:1 | |
| | nitrile | Styrene | Methylstyrene | 120° C. | 20° C. | 120° C. | 20° C. | 120° C. | 20° C. |
| Luran 368R | 23.1^{#} | 76.9^{#} | — | clear | insoluble | clear | clear | clear | clear |
| | | | | solution | | solution | solution | solution | solution |
| Luran 388S | 32.8^{#} | 67.2^{#} | — | insoluble | insoluble | clear | clear | clear | cloudy |
| | | | | | | solution | solution | solution | solution |
| Luran HH120 | 30.7^{#} | — | 69.3^{#} | insoluble | insoluble | clear | insoluble | clear | insoluble |
| | | | | | | solution | | solution | |
| Tyril 790 | 28.9^{#} | 71.1^{#} | — | clear | insoluble | clear | clear | clear | cloudy |
| | | | | solution | | solution | solution | solution | solution |
| Tyril 867E | 26.0^{#} | 74.0^{#} | — | clear | insoluble | clear | clear | clear | clear |
| | | | | solution | | solution | solution | solution | solution |
| Tyril 875 | 26.0^{#} | 74.0^{#} | — | clear | insoluble | clear | clear | clear | clear |
| | | | | solution | | solution | solution | solution | solution |
| Tyril 905 | 21.5^{#} | 78.5^{#} | — | clear | insoluble | clear | clear | clear | cloudy |
| | | | | solution | | solution | solution | solution | solution |
| Elix 280G | 23.7^{#} | 76.3^{#} | — | clear | insoluble | clear | clear | clear | clear |
| | | | | solution | | solution | solution | solution | solution |
| Aldrich, | 25* | | — | insoluble | insoluble | clear | clear | clear | clear |
| catalogue no. | | | | | | solution | solution | solution | solution |
| 182850 | | | | | | | | | |
| Aldrich, | 30* | | — | clear | insoluble | clear | insoluble | clear | insoluble |
| catalogue no. | | | | solution | | solution | | solution | |
| 182869 | | | | | | | | | |

^{#}NMR determination, 1H, 400 MHz, C₂D₂Cl₄/TMS;
*FIGURES from Aldrich;
Luran ® is a trademark of the manufacturer Styrolution;
Tytil ® is a trademark of the manufacturer Styron,
Elix is a trademark of the manufacturer Elix Polymers.

In this way, it was possible to show that styrene-based SAN polymers having an acrylonitrile content of less than 30% by weight have particularly good solubility in solvents mixtures (1:1) of 1-methoxy-2-propanol and diacetone alcohol preferred in accordance with the present invention. Thus, SAN copolymers having an acrylonitrile content in the range of ≧20% by weight to ≦30% by weight are particularly preferred in the context of the present invention, especially in combination with a solvent mixture of 1-methoxy-2-propanol and diacetone alcohol.

### Example 5

### Production of Coated Films

The coating compositions from Examples 1 to 3 and Comparative Example 1 were applied to the backing film, for example Makrofol DE 1-1 (Bayer MaterialScience AG, Leverkusen, Germany), by means of a slot coater from the manufacturer TSE Troller AG.

Typical application conditions are as follows:
web speed 1.3 to 2.0 m/min
wet coating material applied 20-150 m
air circulation dryer 90-110*C, preferably in the region of the TG of the polymer to be dried.
residence time in the dryer 3.5-5 min.

The coating was effected roll to roll, meaning that the polycarbonate film was unrolled in the coating system. The film was conducted through one of the abovementioned application units and contacted with the coating solution. Thereafter, the film with the wet coating was run through the dryer. After leaving the dryer, the now dry coating was typically provided with a lamination film, in order to protect it from soiling and scratching. Thereafter, the film was rolled up again.

For the testing of the final properties of the product, the coated film, after leaving the dryer, can first be cured with a UV lamp and then provided with a laminating film.

### Example 6

### Testing of Blocking Resistances

The coated sides of the non-UV-cured films produced in Example 5 were covered with a laminating film of the GH-X 173 A type (Bischof+Klein, Lengerich, Germany) and weighted down with an aluminium sheet of dimensions 4.5×4.5 cm² and a weight of 2 kg at about 23° C. for 1 h. Thereafter, the weight and the lamination film were removed and the surface of the coating was checked visually for changes. The results are summarized in Table 1.

TABLE 1
Blocking resistance of the coatings

| | | Blocking |
|---|---|---|
| Coating composition | Layer thickness on 250 μm PC film | resistance |
| Example 4 | 20 μm | OK |
| Example 2 | 14 μm | OK |
| Example 3 | 15 μm | OK |

As apparent from the results in Table 1, the inventive films with the inventive coatings already have adequate blocking resistance for further processing after drying on the films.

### Example 7

### Forming of the Coated Films and Curing of the Coatings

The HPF forming tests were performed on an SAMK 360 system (manufacturer: HDVF Kunststoffmaschinen GmbH). The mould was electrically heated to 100° C. The film heating was undertaken by means of IR emitters at 240-260-280° C. The heating time was 16 seconds. A film temperature of about 170° C. was attained. The forming was effected at a forming pressure of 100 bar. The forming mould was a heating/ventilation panel (HV panel).

The appropriate film sheet was fixed at an exact position on a pallet. The pallet passed through the forming station into the heating zone and resided therein for the time set (16 s). In the course of this, the film was heated in such a way that the film briefly experienced a temperature above the softening point; the core of the film was about 10-20° C. colder. As a result, the film was relatively stable when it is run into the forming station.

In the forming station, the film was fixed by closing the mould over the actual mould; at the same time, the film was formed over the mould by means of gas pressure. The pressure hold time of 7 s ensured that the film was accurately formed by the mould. After the hold time, the gas pressure was released again. The mould opened and the formed film was run out of the forming station.

The film was subsequently removed from the pallet and could then be cured with UV light.

With the mould used, radii down to 1 mm were formed.

The UV curing of the inventive coating was executed with an evo 7 dr high-pressure mercury lamp (ssr engineering GmbH, Lippstadt, Deutschland). This system is equipped with dichroitic reflectors and quartz discs, and has a specific power of 160 W/cm. A UV dose of 2.0 J/cm² and an intensity of 1.4 W/cm² were applied. The surface temperature was to reach >60° C.

The UV dose figures were determined with a Lightbug ILT 490 (International Light Technologies Inc., Peabody Mass., USA). The surface temperature figures were determined with temperature test strips of the RS brand (catalogue number 285-936; RS Components GmbH, Bad Hersfeld, Germany).

Results for the durability of the coatings which have been crosslinked using the conditions specified can be found in Table 2.

### Example 8

### Test Methods

TABLE 2
Chemical resistance and scratch resistance of the coatings

| Coating composition/ | | | Steel wool |
|---|---|---|---|
| Layer thickness on | | Pencil | (manufacturer: |
| 250 μm PC film | Solvent | hardness | Rakso, No. 00) |
| | IP/MPA/X/EA/MEK | 500 g | 560 g/10 DH |
| | 1 h/RT | Mitsubishi | ΔG/ΔH |
| Example 2/5 μm | 0/0/0/010 | B | 2/1 |
| Example 3/4 μm | 0/0/0/010 | B | 1/7 |
| Example 4/5 μm | 0/0/0/0/0 | H | 3/8 |
| Makrofol DE 1-1 | 0/5/5/5/5 | 3B | 100/285 |
| 250 μm, uncoated | | | |

IP/MPA/X/EA/MEK stands for isopropanol, 1-methoxy-2-propyl acetate, xylene, ethyl acetate, methyl ethyl ketone

As Table 2 shows, the inventive coating, even in a thin version, improves the pencil hardness and scratch resistance of a commercial film. The inventive coating additionally imparts solvent resistance even to solvents that are otherwise very aggressive towards PC.

### Example 9

### Determination of the Refractive Index of the Coatings

The refractive index n as a function of the wavelength of the samples was obtained from the transmission and reflection spectra. For this purpose, films of thickness of about 100-300 nm from Examples 2 to 3 and Comparative Example 1 were spun onto quartz glass carriers. The transmission and reflection spectrum of this layer assembly was measured with a “CD-Measurement System ETA-RT” from the manufacturer AudioDev, and then the layer thickness and the spectral profile of n were fitted to the measured transmission and reflection spectra in the range of 380-850 nm. This was done with the spectrometer's internal software and additionally required the refractive index data for the quartz glass substrate, which were determined beforehand in a blank measurement. The refractive indices for the cured coating materials are based on the wavelength of 589 nm and hence correspond to n_{D}²⁰.

TABLE 3
Refractive indices of the coatings

| Coating with the coating material from | n_{D}²⁰ |
|---|---|
| Example 2 | 1.544 |
| Comparative Example 1 | 1.511 |

It was possible to show that the inventive use of SAN polymers, compared to polymethylmethacrylate in the comparative example, was able to more closely match the refractive index of the coating to the refractive index of a polycarbonate film (n_{D}²⁰ of 1.585), which leads to an advantageous reduction in the rainbow phenomenon.

### Example 10

### Determination of the Intensity of the Rainbow Effect

TABLE 4
Evaluation of the reflection spectra

| | | Max. peak-valley | |
|---|---|---|---|
| | | value (mPV) in the | |
| Coating composition/ | Reflection | range of >400 nm | Newton rings |
| Layer thickness on | (R) | to <650 nm | rnPV/2/R*1000 |
| 250 μm PC film | (%) | (%) | (#) |
| Example 2/5 μm | 9.2 | 0.5 | 27 |
| Comparative | 8.7 | 1.3 | 74 |
| Example 1/5 μm | | | |

At values for the Newton rings below 30, oiling is no longer perceptible to the naked eye under fluorescent tubes. The SAN-based coating from Example 2 shows a value of 27. Nor are there any disruptive rainbow effects on the surface in high-gloss form with a black backprint.

Comparative Example 1, in contrast, under the same conditions with the same layer thickness of the coating of 5 μm, shows distinctly disruptive coloured interference patterns. With a value of 74 for the Newton rings, this observation is also clearly confirmed by the reflection spectrum.

Through the use of the inventive coating compositions, the rainbow effect is much less marked than when polymethylmethacrylate is used as the thermoplastic polymer. This happens even at layer thickness 5 μm, i.e. within a range where the rainbow effect is at its most marked.

It has thus been shown that the coating compositions and films coated thereby achieved a particularly advantageous combination of scratch resistance, solvent resistance, and a reduction in the unwanted oiling effect on film surfaces.

Thus, the coating composition and coated films according to the present invention are particularly suitable for use for production of plastics parts, especially in film insert moulding processes.

1.-15. (canceled)

16. A coating composition comprising
(a) at least one styrene-acrylonitrile copolymer in a content of at least 30% by weight of the solids content of the coating composition;
(b) at least 30% by weight of a UV-curable reactive diluent;
(c) 0.1 to 10 parts by weight of at least one photoinitiator; and
(d) at least one organic solvent,
where the proportion of ethylenically unsaturated groups is at least 3 mol per kg of the solids content of the coating composition.

17. The coating composition as claimed in claim 16, wherein the styrene-acrylonitrile copolymer (a) has an acrylonitrile content in the range of ≧20 and ≦30%.

18. The coating composition as claimed in claim 16, wherein the at least one UV-curable reactive diluent (b) comprises bifunctional, trifunctional, tetrafunctional, pentafunctional or hexafunctional acrylic and/or methacrylic monomers.

19. The coating composition as claimed in claim 16, wherein the at least one UV-curable reactive diluent (b) comprises alkoxylated diacrylates and/or dimethacrylates, alkoxylated triacrylates and/or trimethacrylates, alkoxylated tetraacrylates and/or tetramethacrylates, alkoxylated pentaacrylates and/or pentamethacrylates, alkoxylated hexaacrylates and/or hexamethacrylates, aliphatic urethane acrylates, polyester acrylates, polyacryloylacrylates and mixtures thereof.

20. The coating composition as claimed in claim 16, wherein the at least one UV-curable reactive diluent additionally comprises monofunctional monomers in at least 20% by weight of the total proportion of reactive diluent, preferably methyl methacrylate or styrene.

21. The coating composition as claimed in claim 16, wherein the solvent is selected from the group consisting of 1-methoxy-2-propanol, diacetone alcohol, 2,2,3,3-tetrafluoropropanol, and mixtures thereof.

22. The coating composition as claimed in claim 16, wherein the solvent comprises diacetone alcohol and/or 1-methoxy-2-propanol.

23. The coating composition as claimed claim 16, wherein the solvent comprises a mixture of at least 50% by weight of diacetone alcohol and 1-methoxy-2-propanol.

24. A laminate comprising a substrate and a surface coating, obtained by coating the substrate with a coating composition as claimed in claim 16.

25. The laminate as claimed in claim 24, wherein the substrate is a film.

26. The laminate as claimed in claim 25, wherein the film comprises polycarbonate and/or copolycarbonate.

27. A process for producing a coated film, comprising the steps of:
(i) coating a film with a moulding composition comprising
(a) at least one styrene-acrylonitrile copolymer in a content of at least 30% by weight of the solids content of the coating composition;
(b) at least 30% by weight of a UV-curable reactive diluent;
(c) 0.1 to 10 parts by weight of at least one photoinitiator; and
(d) at least one organic solvent,
where the proportion of ethylenically unsaturated groups is at least 3 mol per kg of the solids content of the coating composition;
(ii) drying the coating;
(iii) optionally cutting the film to size, delaminating, printing and/or thermally or mechanically forming the film;
(iv) irradiating the coating with UV radiation to cure the coating.

28. The process as claimed in claim 27, wherein the film comprises polycarbonate and/or copolycarbonate.

29. A method for production of plastics parts in film insert moulding processes comprising utilizing the coating composition as claimed in claim 16.

30. A plastics parts for the automotive, transport, electrical, electronics and construction industries comprising the coating composition as claimed in claim 16.
